(19) United States
(12) Patent Application Publication
(10) Pub. No.: US 2007/0168492 A1
(43) Pub. Date: Jul. 19, 2007

(54) Equipment Maintenance Assisting Method and Equipment Maintenance Assisting Server

(75) Inventors: Koichiro TANIKOSHI, Chiyoda-ku, Tokyo, MD (JP); Yasuo SATO, Chiyoda-ku, Tokyo (JP); Hideaki SUZUKI, Chiyoda-ku, Tokyo (JP); Chihiro FUKUI, Chiyoda-ku, Tokyo (JP)

Correspondence Address: HOGAN & HARTSON L.L.P., 1999 AVENUE OF THE STARS, SUITE 1400, LOS ANGELES, CA, 90067, US

(73) Assignee: HITACHI, LTD., Tokyo (JP)

(21) Appl. No.: 11/685,113

(22) Filed: Mar. 12, 2007

Related U.S. Application Data
(63) Continuation of application No. 10/084,834, filed on Feb. 26, 2002.

(30) Foreign Application Priority Data
Nov. 9, 2001 (JP) 2001-344926

(51) Int. Cl. G06F 15/173

(52) U.S. Cl. 709/223

(57) ABSTRACT

The system includes: an equipment data recording block 313 for recording one or more than one equipment information; a profile recording block 312 for storing a customer profile describing a customer request; an analysis block 311 for analyzing the equipment data recorded in the equipment data recording block 313, according to the customer profile, and creating a maintenance service assisting program and a maintenance enterprise assisting program; and a communication block 314 for transmitting the maintenance service assisting program to the customer, and the maintenance enterprise assisting program to the maintenance enterprise.

### BACKGROUND OF THE INVENTION

The present invention relates to a technique for assisting equipment maintenance and in particular, to a technique for providing service to assist a customer and maintenance engineer to perform an appropriate maintenance as desired by the customer.

An enterprise has various equipment and operates it for various objects. For example, an electricity-related equipment may be a power station, a substation, power receiving equipment. In order to smoothly operate equipment related to the enterprise, it is generally necessary to inspect and repair the equipment and replace parts periodically or when required.

Conventionally, for example, a customer who receives the maintenance service can have only a fixed service according to a fixed contract. For example, when an equipment has been operated for a predetermined time, a predetermined inspection is performed and further, when the equipment has been operated for a predetermined time, a particular part is replaced with a new one. The customer pays a service fee for the various maintenance work, parts used for the maintenance, or according to the period of time of the maintenance contract. In this method, even when the parts are in a good condition not requiring replacement are also subjected to the maintenance service determined in advance.

### SUMMARY OF THE INVENTION

In contrast to the aforementioned, recently, it has become possible to select a maintenance service according to the condition of the equipment. In this method, the equipment characteristic values are periodically collected directly or at remote control. By using the collected values, condition of a particular part is checked directly or indirectly based on a deterioration model, and the maintenance-engineer decides the contents of the maintenance service and propose it to the customer. The customer orders a maintenance work according to the proposal. However, in this method also, the customer cannot select a service work. That is, the customer can select a service only within a service range offered by the company with whom a contract is made. Moreover, in such a maintenance service according to the condition of the equipment, it is necessary to collect information periodically. However, the enterprise which can do that is limited to particular ones and there is only a small range for selecting a maintenance enterprise.

As a result, a customer accepts the limited maintenance service offered by the maintenance service enterprise. In order to assure operation of the equipment, the maintenance quality cannot be lowered. Accordingly, the customer accepts the maintenance service which is assumed to be sufficient. Accordingly, there is a possibility that an excessive maintenance service is performed. As a result, the maintenance cost may be higher than is required. However, it is difficult to determine whether the maintenance service currently performed is appropriate or not.

It is therefore an object of the present invention to provide a technique to assist a customer enterprise to easily check whether its equipment requires maintenance work or not. Another object is to provide a technique that assists equipment maintenance service enterprises to propose service contents which can be offered, and customer to order maintenance work that can easily be performed. Still another object is to provide information for the customer to determine whether maintenance work is required or not and a technique for the customer to determine objectively which equipment maintenance service enterprise is offering maintenance work most appropriate and to order maintenance service at the most possible low cost.

In order to solve the first problem, the first invention provides an equipment maintenance work assisting method using a maintenance work assisting server which can be connected to customer systems via a network so as to assist the customer systems. For this, the server accepts and stores a maintenance service content which a customer has specified from the customer system and information indicating a range that can be disclosed about a customer equipment. Moreover, the server fetches and analyzes equipment information about the customer equipment according to a maintenance service content which has been loaded from the customer system, and deciding whether a condition for performing maintenance is satisfied; and when it is decided that the maintenance is required, the server creates a maintenance service assisting program that can be used for maintenance order and that includes information serving as a basis to determine that the maintenance is required and information required for maintenance order, and transmitting the program to the customer via the network.

Moreover, in order to solve the second problem, the second invention provides an equipment maintenance work assisting method using a maintenance work assisting server which can be connected to equipment maintenance service enterprise systems via a network so as to assist the equipment maintenance service enterprise systems. For this, the server accepts and stores an available maintenance work menu from the respective equipment maintenance service enterprise systems. Moreover, when a maintenance order from a customer system to an equipment maintenance service enterprise is accepted, the server creates a maintenance enterprise assisting program that includes information required for fetching the equipment information of the customer which has made the maintenance order and can be used for maintenance work and transmitting the program to the equipment maintenance service enterprise via the network.

Furthermore, in order to solve the third problem, the third invention provides an equipment maintenance work assisting method using a maintenance work assisting server which can be connected to customer systems and equipment maintenance service enterprise systems via a network so as to assist the customer system and equipment maintenance service enterprise systems. For this, the server accepts and stores a maintenance service content which a customer has specified from the customer system and information indicating a range that can be disclosed about a customer equipment. The server accepts and stores an available maintenance work menu from the respective equipment maintenance service enterprises and fetches and analyzes equipment information about the customer equipment according to a maintenance service content which has been loaded from the customer system, and decides whether a condition for performing maintenance is satisfied. When it is decided that the maintenance is required, the server creates a maintenance service assisting program that includes information necessary for maintenance order including identification of an equipment maintenance service enterprise and that can be used for maintenance order and, and transmitting the program to the customer system via the network. Upon acceptance of a maintenance order from a customer system to an equipment maintenance service enterprise, the server creates a maintenance enterprise assisting program that includes information necessary for fetching the equipment information of the customer which has made the order and that can be used for maintenance work, and transmitting the program to the equipment maintenance service enterprise system via the network.

Additionally, the first and second invention may further comprise steps of: accepting, in addition to the maintenance service content to be received by the customer, further equipment information of the customer equipment that can be disclosed, and creating and storing statistical data about the equipment maintenance; and transmitting the statistical data to a customer system which has made a request for the data.

Moreover, the second and third inventions may further comprise steps of: accepting, in addition to the maintenance service content to be received by the customer, equipment information of the of the customer equipment which can be disclosed as information and creating statistical data concerning the equipment maintenance; and upon reception of a request from an equipment maintenance service enterprise, transmitting the statistical data to the equipment maintenance service enterprise system.

Other objects, features and advantages of the invention will become apparent from the following description of the embodiments of the invention taken in conjunction with the accompanying drawings.

### BRIEF DESCRIPTION OF THE DRAWINGS

FIG. 1 shows an outline of a business according to the present invention.

FIG. 2 shows a brief flow of the business according to the time flow according the present invention.

FIG. 3 is a block diagram constituting the system function configuration used in the present invention.

FIG. 4 shows a detailed flow of the business.

FIG. 5 shows a detailed flow of the business according to a first embodiment.

FIG. 6 shows a detailed flow of the business according to a second embodiment.

FIG. 7 shows a detailed flow of the business.

FIG. 8 explains a profile recording block of a maintenance work assisting server and a data file format in the recording block.

FIG. 9A to FIG. 9C show screen examples used for input and output: FIG. 9A shows an example of a customer profile loading screen; FIG. 9B shows an example of a maintenance enterprise profile loading screen; and FIG. 9C shows an example of maintenance order decision screen.

FIG. 10 shows an example of basis display screen.

FIG. 11 is a block diagram showing a system configuration of a customer system, an equipment maintenance information provider system and hardware system that can be used in an equipment maintenance service enterprise.

FIG. 12 explains a function configuration of a maintenance service assisting program.

FIG. 13 shows an example of a maintenance enterprise assisting screen.

FIG. 14 shows a function configuration of a maintenance enterprise assisting program.

### DETAILED DESCRIPTION OF THE EMBODIMENTS

Description will now be directed to embodiments of the present invention with reference to the drawings.

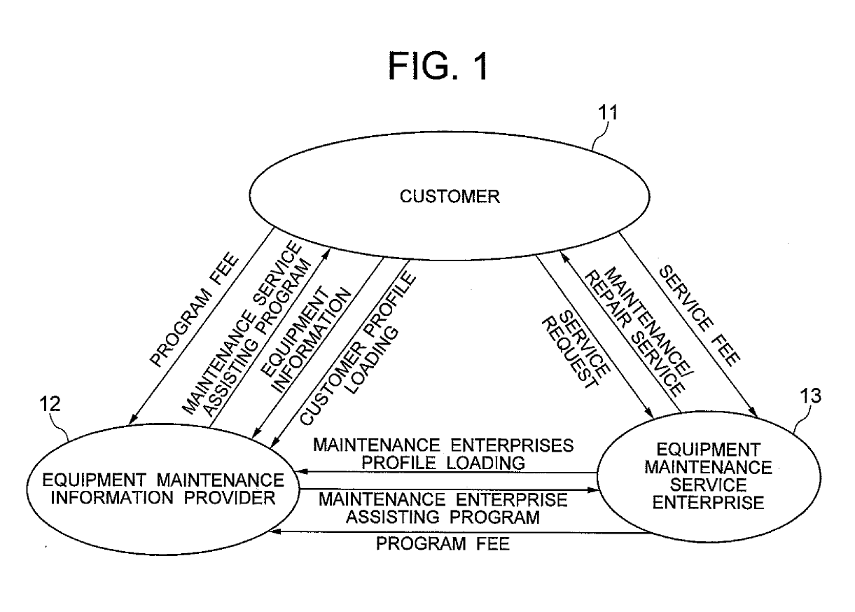

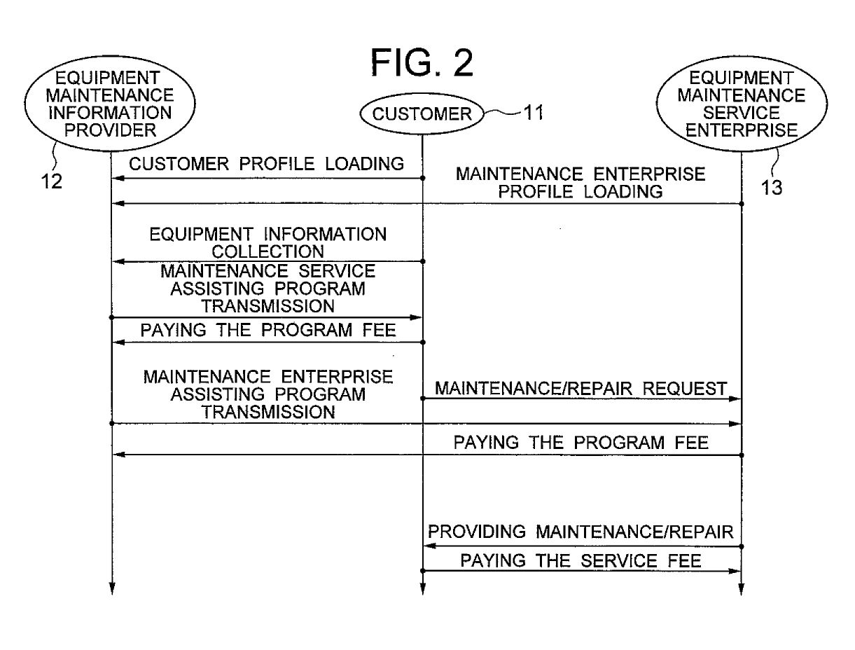

Firstly, referring to FIG. 1 and FIG. 2, explanation will be given on an outline of the business to which the present invention is applied. FIG. 1 shows an outline of the business of the present invention, and FIG. 2 briefly shows a time-based flow of the business of the present invention.

In FIG. 1, an equipment maintenance service enterprise 13 offers a maintenance service to a customer 12 [sic]. And an equipment maintenance information provider 12 as a subject of the service providing information required for equipment maintenance offers maintenance-related information to the customer 11 and to the equipment maintenance service enterprise 13. The equipment maintenance information provider 12, the customer 11, and the equipment maintenance service enterprise 13 are connected to one another for offering and receiving information. For this, each of the equipment maintenance information provider 12, the customer 11, and the equipment maintenance service enterprise 13 has a computer as hardware resource which can be used for information transmission/receiving and processing of the transmission/reception information and software for causing the computers to execute a target processing. The computers are connected to one another by a network such as Internet. Accordingly, each of the customer 11, the equipment maintenance information provider 12, and the equipment maintenance service enterprise 13 is an operation subject which is substantially a system held by these subjects, that is a hardware system in which software has been installed. Accordingly, hereinafter, the customer 11 means a customer system, the equipment maintenance information provider 12 means an equipment maintenance provider system, and the equipment maintenance service enterprise 13 means an equipment maintenance service enterprise system, unless otherwise specified.

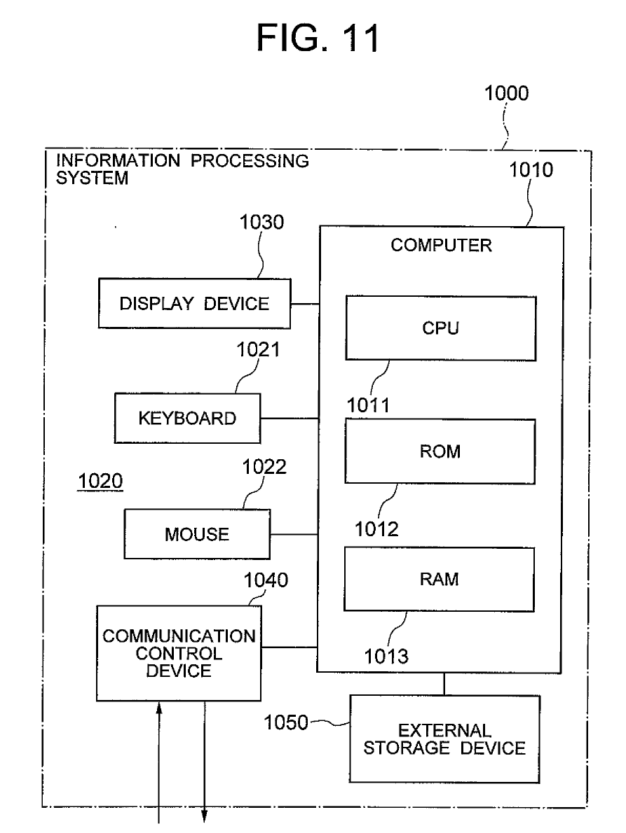

As a hardware resource, for example, a system having configuration as shown in FIG. 11 is used. That is, the system comprises: a computer 1010; an input device 1020 including a keyboard 1021 and a mouse 1022; a display device 1030; a communication control device 1040 for connection to the network; and an external storage device 1050. The computer 1010 includes a central processing unit (CPU) 1011, a read only memory (RON) 1012, and a random access memory (RAM) 1013. The external storage device 1050 can be used as a storage device for a database and can contain a program executed by the CPU 1011. It should be noted that the system of the customer 11 and the system of the equipment maintenance service enterprise 13 can use a similar computer system.

Next, referring to FIG. 2, explanation will be given on the flow of the maintenance assisting service in the business to which the present invention is applied.

The customer 11, firstly, loads a maintenance service content to be performed for its equipment and equipment information which may be opened for the maintenance in a form of a customer profile to the equipment maintenance information provider 12. On the other hand, the equipment maintenance service enterprise 13 loads a maintenance work menu which can be provided by itself in a form of a maintenance enterprise profile, to the system of the equipment maintenance information provider 12.

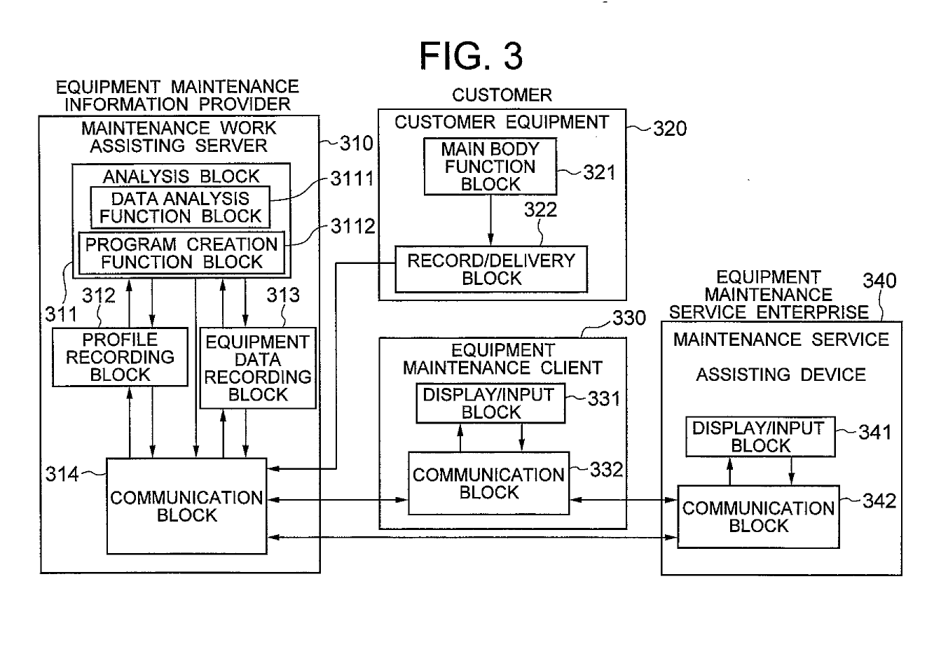

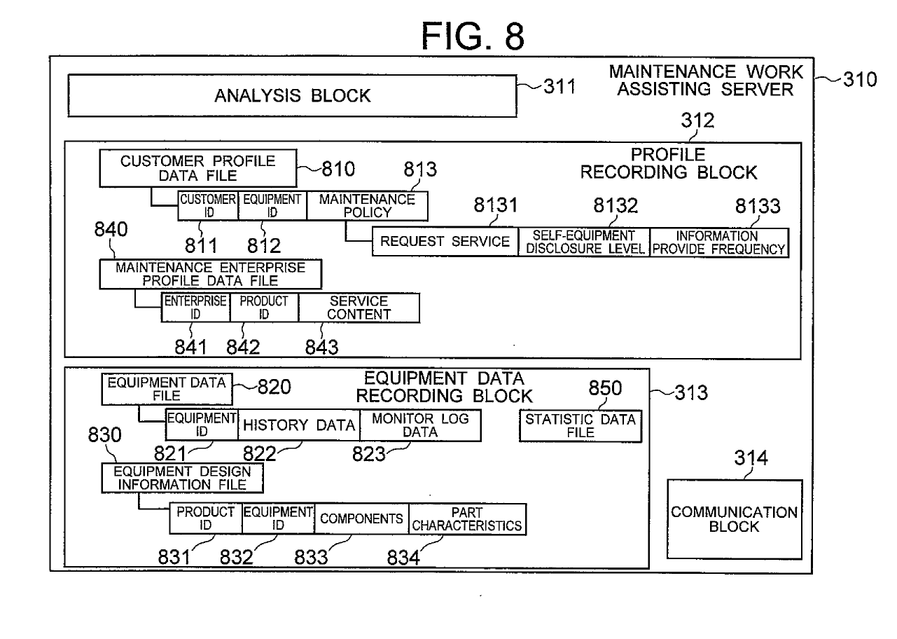

The equipment maintenance information provider 121 stores the content described in the customer profile (customer profile data) in a customer profile data file 810 (see FIG. 8) of the storage device such as a profile recording block 312 (see FIG. 23 and FIG. 8) provided, for example, in the external profile device 1050. Moreover, the equipment maintenance information provider 12 fetches information from the customer equipment according to the content described in the customer profile and stores the information in an equipment data file 810 (see FIG. 8) of the storage device such as a profile recording block 312 (see FIG. 3 and FIG. 8) provided in the external storage device 1050. An analysis block 311 analyzes a condition described in the customer profile data and the information fetched from the customer equipment. If the analysis result satisfies a condition requiring maintenance, a maintenance service assisting program is generated according to the result. The equipment maintenance information provider 12 transmits the maintenance service assisting program via a communication block 314 to the customer 11.

By using the maintenance service assisting program, the customer can receive information about its equipment, for example, in what condition its equipment is as compared to other equipment, and can receive an advice to which equipment maintenance service enterprise the maintenance is to be ordered. According to such information and advice, the customer 11 indicates to order maintenance to a particular equipment maintenance service enterprise 13. Here, it is possible to reference statistical data showing the maintenance condition about a similar equipment. As a result, it is possible to determine whether the equipment requires maintenance service or not.

According to the content of the customer profile registered (loaded) in advance, a reference fee is specified for the maintenance service assisting program received by the customer 11. Accordingly, the equipment maintenance information provider receives the specified fee for using the program.

On the other hand, the equipment maintenance service enterprise 13 which has received order for maintenance from the customer receives a maintenance enterprise assisting program from the equipment maintenance information provider 12. By using the maintenance enterprise assisting program, the equipment maintenance service enterprise 13 can fetch information related to the equipment of the customer 11 from which an order is received. Moreover, according to equipment to be subjected to the maintenance work, it is possible to fetch information such as equipment stop/start procedure required for the maintenance work.

In this maintenance enterprise assisting program, the equipment maintenance information provider 12 can add a certain limit to the information related to the equipment of the customer 11. By using information from the maintenance enterprise assisting program, the equipment maintenance service enterprise 13 provides maintenance/repair service to the equipment of the customer 11 and receives a service fee for that.

For the maintenance enterprise assisting program received by the equipment maintenance service enterprise 13, its reference fee is set according to the content of the maintenance enterprise profile registered (loaded) in advance. According to this setting, the equipment maintenance information provider receives a fee for using the program.

Next, referring to FIG. 3 and FIG. 8 to FIG. 14, explanation will be given on a specific system function configuration of the present invention.

FIG. 3 shows a function configuration of the entire system of the present invention. It should be noted that in this embodiment, for simplifying the explanation, only one customer 11 and only one equipment maintenance enterprise 13 are shown, although actually a plurality of customers 11 and a plurality of equipment maintenance enterprises 13 exist. As shown in FIG. 3, the equipment maintenance information provider 12 includes a maintenance work assisting server 310. The customer 11 includes a customer equipment 320 and an equipment maintenance client 330. Moreover, the equipment maintenance service enterprise 13 includes a maintenance service assisting device 340. Each of the maintenance work assisting server 310, the customer equipment 320, the equipment maintenance client 330, and the maintenance service assisting device 340 includes a computer or a circuit executing logic operation equivalent to a computer. The computer can have configuration, for example, identical to the hardware system shown in FIG. 11.

The maintenance work assisting server 310 has: an analysis block 311 for analyzing information; a profile recording block 312; a data recording block 313; and a communication block 314 for communication via a network which are realized by software in the computer. These functions can be realized by an equivalent device realizing the respective functions such as an analysis device 311, a profile recording device 312, a data recording device 313, and a communication device 314, by replacing all or part of the corresponding functions. In this case, the server 310 controls operation of these devices.

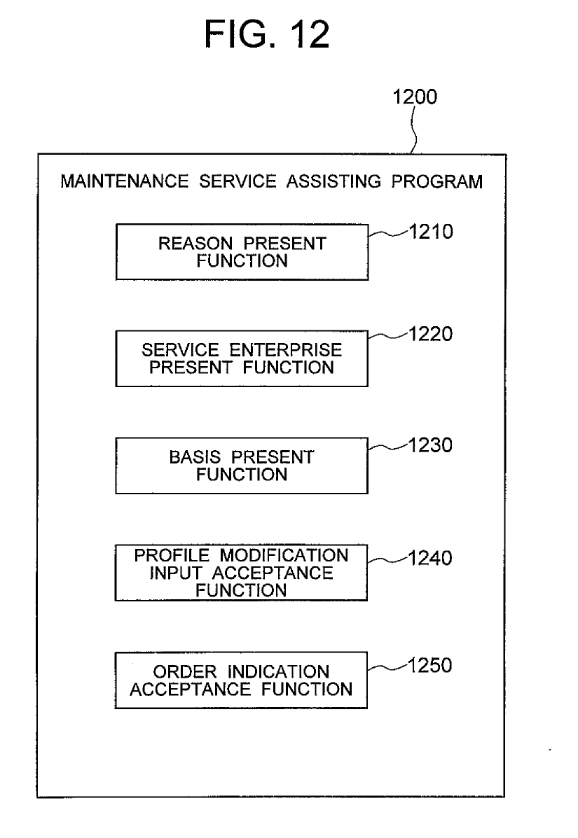

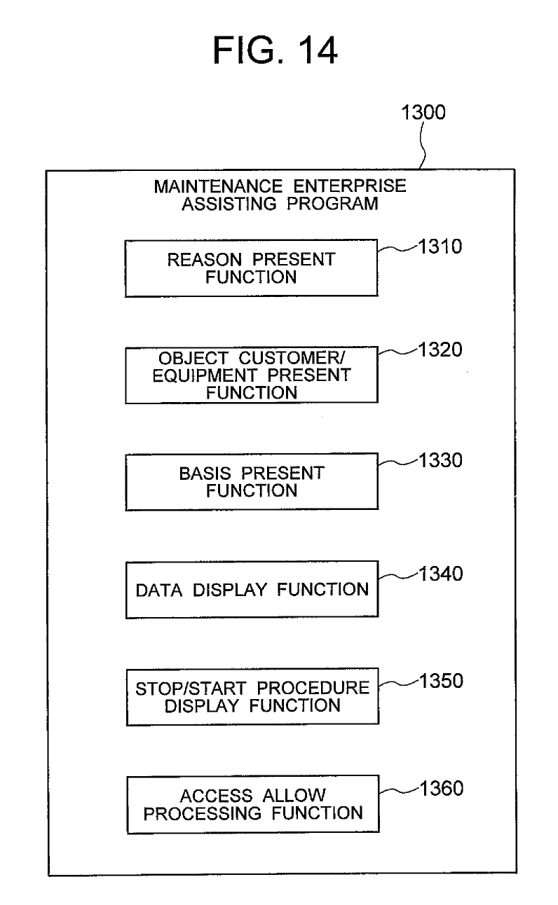

The analysis block 311 has a data analysis function block 3111 for analyzing data, and a program generation function block 3112 for generating a maintenance service assisting program (see FIG. 12) and a maintenance enterprise assisting program (see FIG. 14) according to the analysis result. These are realized by executing a program for generating a program. The program generation function block 3112 has an unfinished version of the maintenance service support program generated in advance for typical items excluding conditions inherent to the equipment of the customer and an unfinished version of the maintenance enterprise assisting program generated in advance for typical items excluding conditions inherent to the equipment maintenance service enterprise.

The data analysis function block 3111 analyzes the equipment condition of the customer according to the customer equipment information. This analysis is, for example, to compare the customer equipment information with a predetermined reference and determine whether maintenance work is required. Here, it is possible that this decision is made, referencing the customer maintenance policy. For example, a strict reference is set and it is decided to perform maintenance when a deviation from the reference is very small. It should be noted that as a reference for deciding whether to perform maintenance, it is possible to use information of other company together with the aforementioned reference or to replace the aforementioned reference. For example, it is possible to use statistical data such as an average value and standard deviation of an equipment identical to at least one of the characteristic values, inspection cycle, inspection content, inspection part of the customer equipment.

For this, the data analysis function block 3111 collects information which can be disclosed on an equipment of identical type in the specific field. The collection is performed according to a condition allowed by the customer. In general, this information is collected as the latest information when deciding whether to perform a maintenance work. Additionally, such information can be collected only as comparison data. For example, information collection can be performed periodically or from time to time if allowed by the customer. The information to be collected is information used for deciding whether to perform maintenance work such as the characteristics of the equipment, inspection cycle, inspection content, inspection part, and the like. The collected information is classified by a category of business, equipment type, form, and the like and they are accumulated in the equipment data recording block 313. Moreover, for the accumulated information, a statistic value such as an average value is obtained in advance. It should be noted that when it is desired to perform comparison excluding data on a target enterprise, statistic data is obtained according to information of the other enterprises of the same category and stored in the equipment data recording block 313. Alternatively, calculation is performed each time. The statistical data may be, as has been described above, an average value, dispersion, standard deviation, and the like. The statistical data may be calculated in advance or calculated at the moment when required. In the example of FIG. 8, a statistical data file 850 is provided.

The program generation function block 3112 describes the information obtained from the aforementioned data analysis for the undefined portion of the unfinished version of the maintenance service assisting program prepared in advance, and completes the maintenance service assisting program 1200. This operation is automatically performed by the analysis block 311. Thus, the maintenance service assisting program 1200 is automatically generated.

Moreover, according to the information for identifying the customer 11 contained in the maintenance request report, a content of the maintenance described in the corresponding maintenance service assisting program, and the maintenance enterprise profile data recorded in the profile recording block 312, the program generation function block 3112 generates an access allowance information such as a password, so that the maintenance enterprise can access data required when performing maintenance work. Here, the data to be accessed may be, for example, an equipment data file 820, an equipment design information file 830, and a statistic data file 850. The analysis block 311 fill in the unfinished version of the maintenance enterprise assisting program with the information for identifying the customer 11, information specifying an equipment to be subjected to maintenance work, and the access allowance information, so as to complete the maintenance enterprise assisting program 1300. This operation is automatically performed by the analysis block. Accordingly, the maintenance enterprise assisting program 1300 is automatically generated.

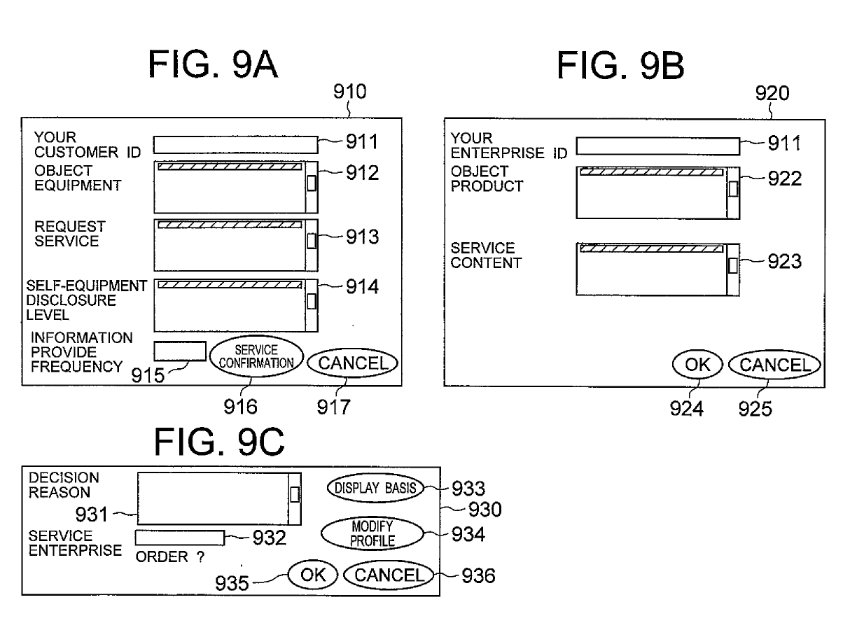

As shown in FIG. 12, the maintenance service assisting program 1200, for example, causes the computer to execute: reason present function 1210 for presenting a reason why it is decided to perform maintenance work; a service enterprise present function 1220 for displaying a service enterprise appropriate to provide the maintenance service; a basis present function 1230 for showing a basis when a basis display request is accepted; a profile modification input reception function 1240 for accepting a modification input when request for modification of the customer profile is accepted; and an order indication acceptance function 1250 for accepting an order indication. This maintenance service assisting program 1200 is executed in the system of the customer 11, i.e., in the equipment maintenance client 330, for example, to display a screen shown in FIG. 9C so as to assist the customer 11 to order a maintenance work. This maintenance assisting program may have configuration appropriate for being executed in the system of the customer 11 or executed via a browser.

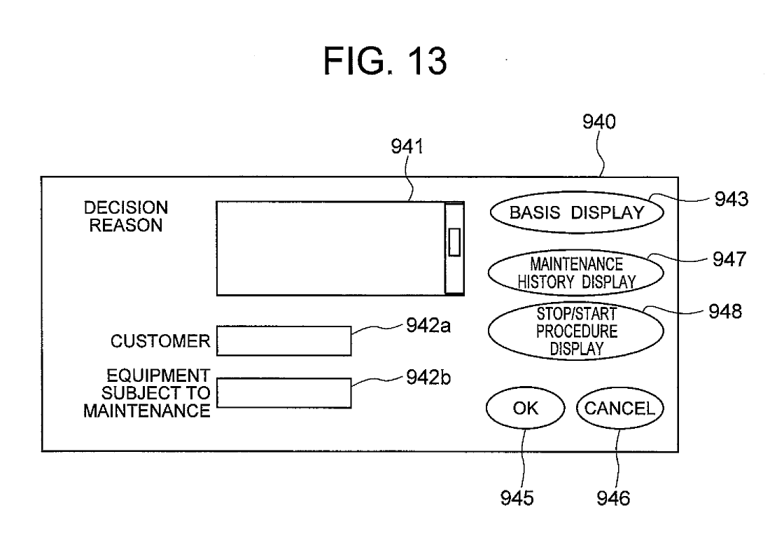

As shown in FIG. 14, for example, the maintenance enterprise assisting program 1300, causes the computer to execute: a reason present function 1310 for presenting a reason why it has been decided to perform maintenance work; object customer/equipment display function 1320 for displaying the customer and the equipment to which the maintenance service is to be provided; a basis present function 1330 for showing a basis when a basis display request is accepted; a data display function 1340 for fetching and displaying fetching and displaying data related to the equipment of the customer requiring maintenance work from a customer record/delivery block 322 or via the maintenance work assisting server 310 of the equipment maintenance information provider; a stop/start procedure display function 1350 for fetching and displaying information indicating a stop procedure and a start procedure of the equipment to be subjected to the maintenance work; and an access allowance processing function 1360 for processing an access allowance to the customer data. This maintenance enterprise assisting program 1300 is executed in the system of the equipment maintenance service enterprise 13, i.e., executed in the maintenance service assisting device 340 and displays, for example, a screen shown in FIG. 13 and assists the equipment maintenance service enterprise 13 in performing the maintenance work. This maintenance enterprise assisting program 1300, like the maintenance assisting program, may be executed in the system of the equipment maintenance service enterprise 13 or may be executed via a browser according to the purpose.

As for the maintenance service assisting program and the maintenance enterprise assisting program, the program generation function block 3112 may cause the maintenance service assisting program and the maintenance enterprise assisting program to indicate and advise at least one of the following information: the time of replacing the equipment of the customer; an advice for a new type to replace the old one; a maintenance enterprise; and a maintenance menu that can be provided by the maintenance enterprise.

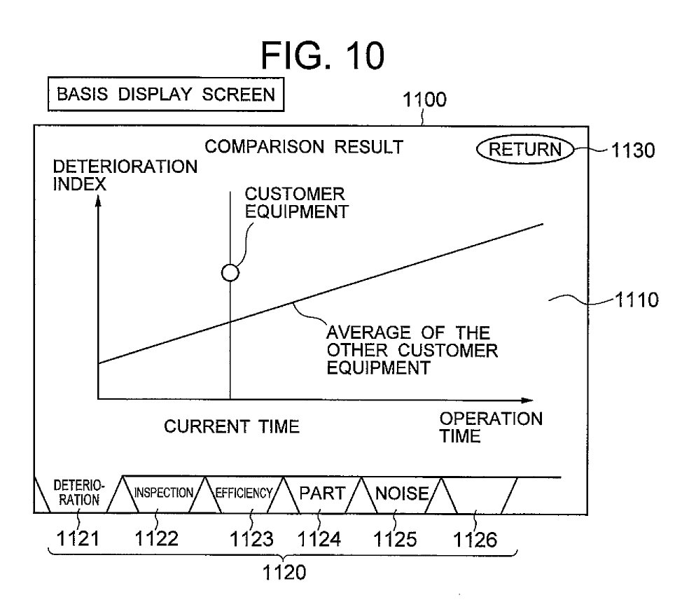

Moreover, the program generation function block 3112 can add to the maintenance service assisting program and the maintenance enterprise assisting program a function for generating and presenting a screen for comparison with condition of a similar equipment of the other enterprise. For example, it is possible to add a function to display at least one of the customer equipment characteristic values, inspection cycle, inspection content, and inspection part so as to be compared with average values and standard deviation data of a similar equipment. In this embodiment, presentation is performed by making it possible to reference in the maintenance service assisting program and the maintenance enterprise assisting program. FIG. 10 is an example of such presentation. It is also possible to reference the comparison result separately from the aforementioned programs.

It should be noted that the maintenance work assisting server 310 can further provide a transmission decision block for deciding a transmission destination, transmission timing, and transmission frequency of the maintenance service assisting program or the maintenance enterprise assisting program. For example, the transmission destination can be decided by referencing at least one of the customer profile data file 810, the maintenance enterprise profile data file 840, equipment data file 820 including repair information, and the equipment design information file 830 including part lot information.

The customer equipment 320 includes a main body function block 321 and a record/delivery block 322. The record/delivery block 322 collects and records necessary information from the main body function block 321 of the customer equipment according to a predetermined method and a predetermined cycle or a method and cycle indicated by the maintenance work assisting server 310. The main body function block 321 is a part that the equipment operates for that purpose. In formation from the main body function block 321 includes signals from various sensors provided in the main body function block 321 and various instructions given to the main body function block 321. The signals from the sensors may be, for example, detection signal of a sensor indicating penetration of insulating oil. Moreover, as information related to the various instructions, for example, there is a counter value indicating the switch on/off instruction count. The record/delivery block 322 may restrict output of a part of the collected information. Moreover, the record/delivery block 322 may output, instead of raw data, a quantity processed into a function to grasp the operation condition of the equipment.

Moreover, the equipment maintenance client 330 has a display/input block 331 and a communication block 332 for processing information display and instruction input as functions to be realized by software in the computer. The maintenance service assisting device 340 has a display/input block 341 and a communication block 342 for processing information display and instruction input as functions realized by software in the computer. It should be noted that the functions of display/input block 331 and 341 in the equipment maintenance client 330 and the maintenance service assisting device 340 may be realized by a browser prepared in advance in the display/input block 331, 341 by using, for example, a program and format transmitted from the maintenance work assisting server 310.

In the profile recording block 312 of the maintenance work assisting server 310, the customer profile data file 810 and the maintenance enterprise profile data file 840 are recorded. Moreover, in the equipment data record block 313, the equipment data file 820 and the equipment design information file 830 are recorded. FIG. 8 schematically shows configuration of these data.

The customer profile data file 810 controls information of a maintenance policy 813 for each of the customers ID811 and each of the object equipment ID812. The maintenance policy 813 controls information as follows: a request service 8131 which identifies the degree of the maintenance, equipment disclosure level 8132 indicating to which extent the equipment contents can be disclosed, and information providing frequency 8133 indicating how often the information is provided.

The maintenance enterprise profile data file controls information of a product ID842 and a corresponding service content 843 for each of the enterprises ID9411 identifying a maintenance enterprise.

The equipment data file 820 controls for each of the equipment ID821, history data 822 containing measurement values of the equipment together with time and monitor log data 823 containing a slight failure found by the self-monitoring function together with the time.

The equipment design information file 830 controls for each of the products ID831, information of the equipment ID832, components 834, and parts characteristics 834.

Here, the product ID831 and 842 are uniquely assigned to each of the equipment types such as a turbine type A, an incoming panel type B, a breaker type type C expressed, for example, by a combination of letters and numeric such as “TB-A”. The equipment ID811, 821, 832 are uniquely assigned identification for specific equipment such as a turbine No. 1, an incoming panel type B No. 2, a breaker type C No. 3, expressed, for example, by a combination of letters and numeric such as “TB-A-0001”.

The components 833 indicates parts constituting the product such as a blade and a contact, expressed in letters, numeric, or combination thereof such as “CONT-A”. The parts characteristics 834 indicates information for each of the type of the components: a failure history, replacement frequency under a predetermined operation condition, repair frequency, and the like.

Next, referring to FIG. 9A, FIG. 9B, FIG. 9C, and FIG. 13, explanation will be given on a customer profile loading screen, a maintenance enterprise profile screen, a maintenance order decision screen, and a maintenance enterprise assisting screen. These are displayed in the system of the customer 11 and the system of the equipment maintenance service enterprise 13. More specifically, in the display/input block 331 and the display/input block 332 shown in FIG. 3, the screen is displayed and input for that is accepted.

FIG. 9A shows a customer loading screen displayed by the display/input block 331. In FIG. 9A, the customer loading screen 910 includes: a customer ID loading field 911; an object equipment setting field 912; a request service setting field 913; a self-equipment disclosure level setting field 914; an information provide frequency setting field 915; a confirmation button 916; and a cancel button 917. In each of the fields, an operator can input corresponding items. The display/input block 331 accepts inputs from the customer 11.

In the customer ID loading field 911, a customer ID identifying the customer is entered. This is for identifying a customer among a plurality of customers. For example, the customer ID is composed of letters and numeric or combination thereof such as “KI0001”. In the object equipment setting field 912, an ID of the customer equipment to be subjected to maintenance work is entered. This ID is uniquely assigned to each of the specific equipment such as a turbine type A No. 1, an incoming panel type B No. 2, and a breaker type C No. 3 expressed by a combination of letters and numeric such as “TB-A-0001”.

In the request service setting field 913, a maintenance service content desired for the equipment is entered. Here, a menu of predetermined items may be displayed. Moreover, it is also possible to display a menu of decision result of the maintenance enterprise profile (which will be detailed later) loaded in the maintenance work assisting server which is reflected in the profile format. In this case, the customer can select a desired service from this menu. The menu content may be, for example “maintenance of the turbine blade” and “performance maintenance of the entire incoming panel”.

In the self-equipment disclosure level setting field 914, the operator inputs an information disclosure level of the equipment which may be disclosed about the equipment when receiving service. For example, level 1 discloses direct values as they are, level 2 discloses an average value of a certain period of time, level 3 discloses a maximum value. Thus, the information is divided in different ranks and one of the ranks is set. Moreover, it is possible to rank the information as follows. That is, level 1 contains information for identifying an equipment and level 2 does not contain this information. Moreover, information is disclosed completely when using the information for analysis of the self-enterprise, and the disclosure is limited when the information is used for analysis for the other enterprises. Thus, the disclosure level can be defined from various viewpoints and accordingly, these viewpoints can be set in the form of AND/OR condition.

In the information provide frequency 915, the operator sets a condition to receive the maintenance service assisting program. For example, it is possible to set “every X time”, “when an accident is predicted”, “when an accident has happened”, “when deterioration has become P % as compared to an equipment of identical type”, and the like. At the specified timing, the maintenance service assisting program is transmitted to the customer.

The confirmation button 916 is pressed after the aforementioned inputs are performed, so as to accept that the customer 11 has confirmed. When this button is pressed, the information items which have been set are transmitted via the communication block 332 to the communication block 314 of the maintenance work assisting server 310 and are recorded in the profile recording block 312. When a cancel button 917 is pressed, the data entered are canceled and not transmitted.

FIG. 9 shows the display/input block 341 displaying the maintenance enterprise profile loading screen 920 displayed by the display/input block 341. On the maintenance enterprise profile loading screen 920, there are arranged an enterprise ID loading field 921, an object product setting field 922, a service content setting field 923, a confirmation button 924, and a cancel button 925. The display/input block 341 displays these fields according to the format transmitted from the maintenance work assisting server 310 and accepts inputs by the equipment maintenance service enterprise 13.

In the enterprise ID loading field 921, an enterprise ID identifying it is entered. This is for identifying a particular enterprise among a plurality of enterprises. The enterprise ID is expressed by letters, numeric, or combination thereof such as “GID0001”.

In the object product setting field 922, the operator specifies a type of the equipment to be subjected to a maintenance work. This ID is uniquely assigned to each of the types of the equipment such as a turbine type A, an incoming panel type B, a breaker type C. For example, the ID is composed of letters, numeric, or combination thereof such as “TB-A”.

In the service content setting field 923, contents of maintenance service that can be offered are specified such as “service for cleaning part A of the turbine type A” and “service for replacing part Y of the incoming panel type B”. Thus, the service is expressed by the equipment type, its component, and maintenance work for it.

The confirmation button 924 is for accepting the input contents confirmed. When this is specified by the mouse 1022, the information items which have been set are transmitted via the communication block 324 to the communication block 314 of the maintenance work assisting server 310 and recorded in the profile recording block 312. When the cancel button 925 is specified, the data entered is cancelled and is not transmitted.

The display/input block displays a maintenance order decision screen 930 for assisting decision by using the maintenance service assisting program. In the maintenance order decision screen 930 shown in FIG. 9C, there are arranged: decision reason setting field 931, a service enterprise display field 932, a basis display button 933, a profile modification button 934, an OK button 935, and a cancel button 936. The display/input block 331 accepts inputs specified in the respective fields.

The decision reason setting field 931 shows a condition on which the maintenance work assisting server 310 has decided that maintenance is required. For example, “deterioration is P % as compared to the equipment of an identical type” and the like. The service enterprise display field 932 displays an enterprise ID of a selected appropriate equipment maintenance service enterprise 13. The basis display button 933 is pressed when the customer wants to know the basis of the displayed condition. The profile modification button 934 is used to display the customer profile loading screen 910 and accept request for modifying the contents which have been set.

The OK button 935 accepts the order when the customer has agreed to order the maintenance. When the OK button is pressed, by using e-mail or the like, the maintenance is ordered to the equipment maintenance service enterprise 13. When the cancel button is pressed, no order is made.

FIG. 10 shows an example of the basis screen 1100 displayed when the aforementioned basis button 933 is pressed. In FIG. 10, 1110 denotes a result display field, 1120 is a selection tub, and 1130 is a return button. The example shown in FIG. 10 has a result display field 1110 showing a deterioration index of the self-equipment as compared to an average of equipment of an identical type of the other customers. There are various deterioration indexes depending on the equipment. For example, in a power station equipment, the switch on/off count, contamination (penetration) of the insulating oil, or the like can be used as a deterioration index. Here, data of such indexes are collected and calculated to obtain an entire average to serve as a reference. This average is displayed together with the index of the customer to be compared, so that the necessity degree of the maintenance work can be decided. Thus, the conventional difficulty to evaluate the necessity of maintenance can easily be solved by using this graph. For example, when receiving the maintenance service order assistance, the customer can understand that there is a rational reason for performing maintenance according to the graph displayed.

Here, the data indicating conditions of the other enterprises are important in making a decision. That is, when data of the other enterprises have been collected sufficiently, the reference for comparison can have a high accuracy. Accordingly, it is a key point for this business that the other enterprises disclose their data as much as possible. For this, as will be detailed later, the customer which has disclosed data can have compensation. The compensation may depend on the data type and quantity. That is, it is necessary to pay a higher fee for those which can be utilized as statistical data. Moreover, the compensation is not limited to money. For example, the compensation may be a whole or part of service fee. Moreover, it is also possible to discount the service fee.

The selection tub 1120 includes a deterioration display 1121, an inspection display 1122, an efficiency display 1123, a part display 1124, a noise display 1125, and other display 1126. In the state of FIG. 10, the deterioration display 1121 is selected. By using the selection tub 1120, the customer can obtain information about the other conditions not set in the customer profile. For example, when the tub of the part display 1124 is selected, it is possible to utilize information of parts characteristics recorded in the equipment design information file 830 and obtain information to predict the timing of failure of the part of the self-equipment from the failure history of the part of the other equipment. It is also possible for the customer to modify the customer profile data file 810 after observing the basis display screen 1100. Thus, it is possible to perform more appropriate maintenance.

It should be noted that the basis display screen 1100 may be created at the stage when the maintenance service assisting program is created. Moreover, it is also possible, during operation at the equipment maintenance client 330, to dynamically communicate with the maintenance work assisting server 310 and the customer equipment 320, so as to collect equipment information and create display. Either case is limited to the self-equipment disclosure level of the customer profile data file 810 recorded in the profile recording block 312. That is, information not to be disclosed for the other customer is not involved at the stage when the maintenance service assisting program is created. Moreover, when collecting equipment information by communication with the maintenance work assisting server 310 and the customer equipment 320, information not to be disclosed cannot be accessed.

Next, referring to FIG. 13, explanation will be given on the maintenance enterprise assisting screen referenced when the equipment maintenance service enterprise has received a maintenance order.

By using the maintenance enterprise assisting program 1300, the display/input block 341 displays a maintenance order decision screen 940 for assisting in deciding whether to order maintenance. The maintenance enterprise assisting screen 940 shown in FIG. 13 includes a decision reason setting field 941, a customer display field 942a, a maintenance object equipment display field 942b, a maintenance object basis display button 943, a maintenance history display button 947, a stop/start procedure display button 948, an OK button, and a cancel button 946. The display/input block 341 accepts input specified by the customer 11 in each of the fields.

The decision reason setting field 941 displays a condition which is satisfied by the maintenance work assisting server 310. For example, “deterioration P % as compared to an equipment of the identical type”. The customer display field 942a displays a customer ID for identifying an object customer and a customer name. Moreover, the maintenance object equipment 942b displays an equipment to be subjected to maintenance service. The basis display button 943 is pressed when the customer 11 wants to know the basis of the condition displayed. The maintenance history display button 944 is a button to accept a request for displaying the maintenance history information showing what kind of maintenance has been performed for the equipment of the customer. The stop/start procedure display button 948 is a button to accept request for displaying the stop procedure and start procedure of the equipment to be subjected to maintenance work. By providing this button, the maintenance enterprise can stop and start the equipment in safety.

The OK button 945 is used to accept a maintenance order. When the OK button is pressed, maintenance is ordered to the customer 11 by e-mail or the like. When the cancel button 946 is pressed, no order is made.

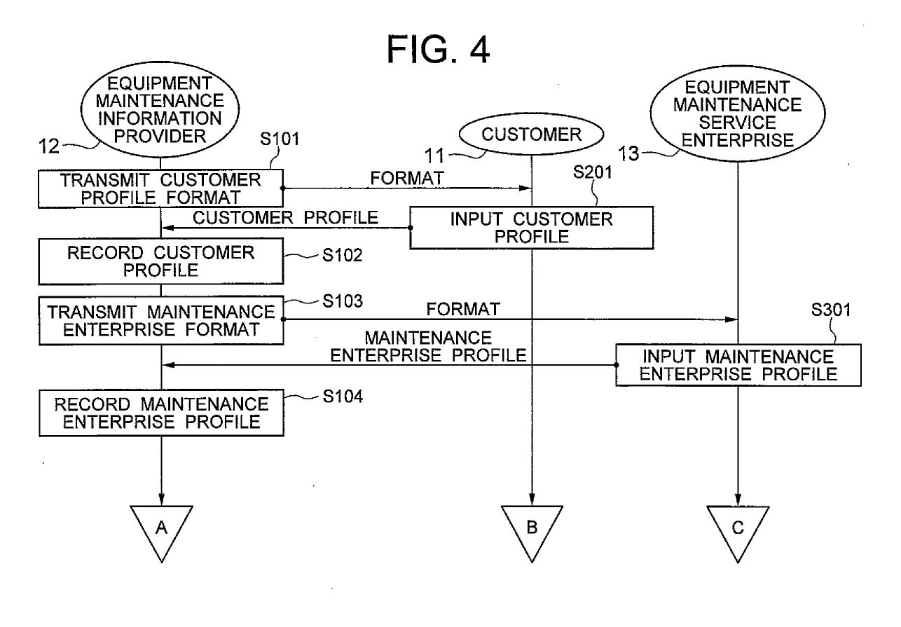

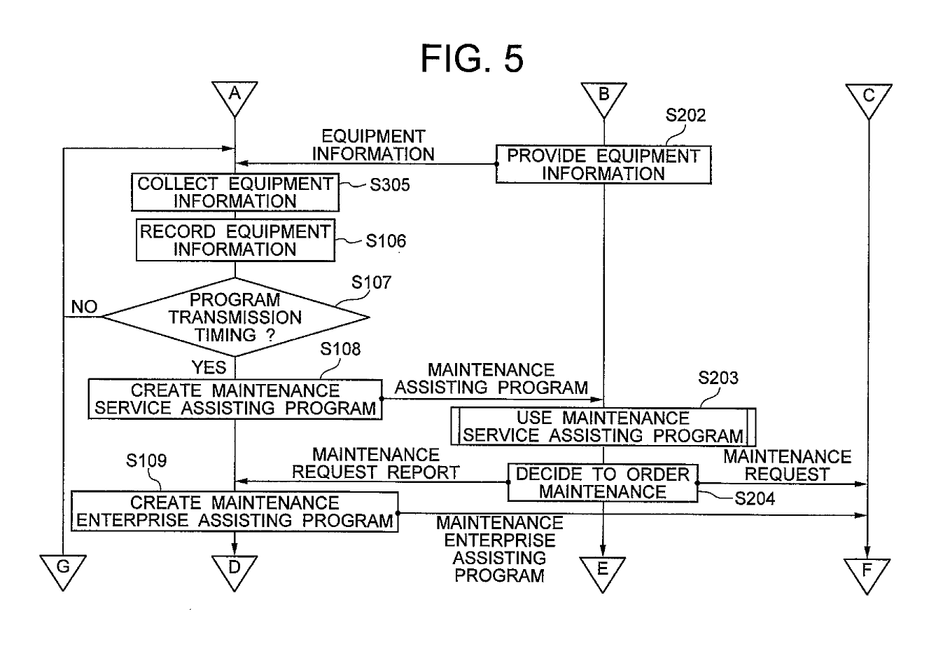

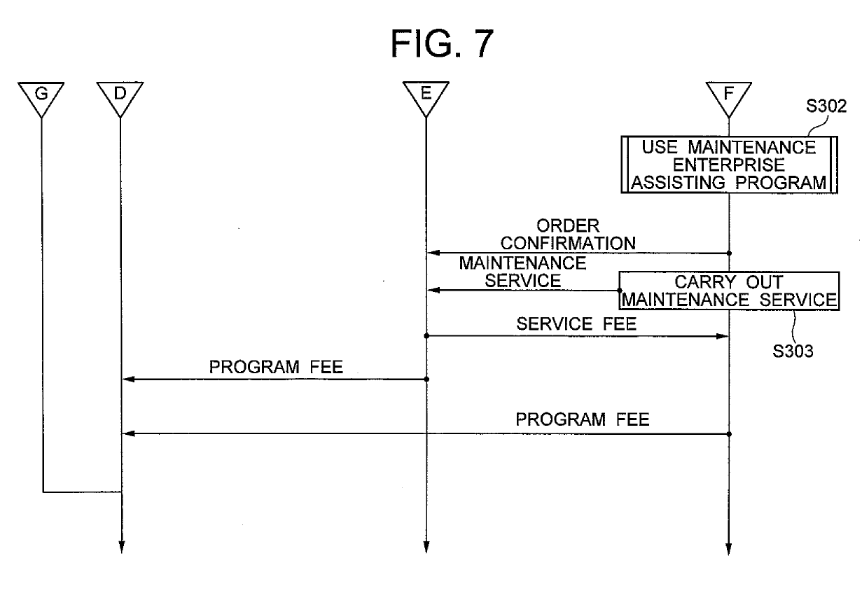

Next, explanation will be given on a business procedure according to the embodiment using the system having the aforementioned configuration with reference to the aforementioned figures and FIG. 4, FIG. 5, and FIG. 7. FIG. 4, FIG. 5, and FIG. 7 show a specific example of the business procedure according to the present embodiment. The symbols A, B, C, and the like in the procedure flow show connections of the flow, and like symbols are connected to like symbols.

Firstly, the maintenance work assisting server 310 of the equipment maintenance information provider 12 transmits a format of the customer profile to the equipment maintenance client 330 of the customer 11 (S101).

The equipment maintenance client 330 uses the aforementioned format to display the customer profile loading screen 910 as shown in FIG. 9A via the display/input block 331 (S201). According to the display on this screen, the display input block 331 receives the inputs by the customer 11. That is, the customer ID loading field 911 accepts the customer ID. The object equipment setting field 912 accepts an ID of the customer equipment to be subjected to the maintenance work. The request service setting filed 913 accepts an input about the maintenance service content to be performed for the equipment entered. In the self-equipment disclosure level setting field 914, an operator enters a disclosure level of the information about the equipment that can be disclosed when accepting service. The disclosure level has ranks as has been described above. Next, in the information provide frequency 915, the operator sets a condition to receive the maintenance service assisting program. Lastly, the service confirmation button 916 is pressed for confirmation. Then, the information entered is transmitted via the communication block 332 to the communication block 314 of the maintenance work assisting server 310 and recorded in the profile recording block 312 (S102). When the cancel button 917 is specified, the data entered is canceled and not transmitted.

Next, the maintenance work assisting server 310 belonging to the equipment maintenance information provider 12 transmits a maintenance enterprise profile format to the maintenance service assisting device 340 belonging to the equipment maintenance service enterprise 13 (S103).

By using the format received, the maintenance service assisting device 340 displays a maintenance enterprise profile loading screen as shown in 920 of FIG. 9B in the display/input block 341 (S301). The equipment maintenance service enterprise 13 enters its ID in the enterprise ID loading field 921. In the object product setting field 922, a type of the equipment to be subjected to its maintenance is set. In the service content setting field 923, the enterprise 13 enters a maintenance service content that can be performed by the enterprise 13. Lastly, when the confirmation button 924 is specified, the information which has been set is transmitted via the communication block 324 to the communication block 314 of the maintenance work assisting server 310 and recorded in the profile recording block 312 (S104). When the cancel button 925 is specified, the data which has been entered is cancelled and not transmitted. The data format recorded becomes the aforementioned maintenance enterprise profile data file 840 shown in FIG. 8.

Among these steps, S101, S102, S103, and S104 may occur in an indefinite order and each of them may occur a plurality of times.

The record/delivery block 322 of the customer equipment collects and records necessary information according to a predetermined method and cycle or a method and cycle specified by the maintenance work assisting server 310 (S202).

The maintenance work assisting server 310 periodically accesses the record/delivery block 322 via the communication block 314 and fetches equipment information (S105). Alternatively, when a predetermined condition is satisfied, the record/delivery block 322 spontaneously transmits equipment information to the communication block 314, so that the communication block 314 can receive the information. The equipment information transmitted may be limited according to a content of the self-equipment disclosure level. In either case, the equipment information received by the communication block 314 is recorded in the equipment data recording block 313 (S106). The data format used here is the equipment data file 820 shown in FIG. 8.

The maintenance work assisting server 310 constantly decides in the analysis block 311 whether a predetermined condition is satisfied (S107). When the condition is not satisfied, control is passed back to the equipment information collection (S105). This condition may be decided by the information provide frequency in the customer profile data file 810 loaded in the customer profile record procedure (S102). For example, when “every X time” has been set, the time lapse is observed and it is decided that the condition is satisfied every X time. If “when an accident is predicted” has been set, then contents of the equipment data file 820 recorded in the equipment data recording block 313 are analyzed and if an accident is predicted with a predetermined probability or above, it is decided that the condition is satisfied. If “upon occurrence of an accident” has been set, then it is decided that the condition is satisfied when the equipment data transmitted from the record/delivery block 322 contains information about an accident. If “P % deterioration as compared to an equipment of identical type” has been set, then contents of the equipment data file 820 recorded in the equipment data recording block 313 are checked. That is, according to the information of the equipment design information file 830, a product ID to which the equipment ID of the customer is retrieved and equipment information items of all the equipment ID belonging to the product ID are analyzed to obtain an average deterioration index. If the equipment of the customer is deteriorated by P % as compared to the average deterioration index, it is decided that the condition is satisfied.

According to this condition, the maintenance work assisting server 310 automatically creates a maintenance service using the analysis block 311 (S108). When a maintenance service assisting program is created, it means that some maintenance work is required except for the periodical condition. The analysis block 311 selects an equipment maintenance service enterprise 13 which is most appropriate for this maintenance work according to the product ID and service content of the maintenance enterprise profile data file 840 registered (loaded) in the profile recording block 312. When a plurality of equipment maintenance service enterprises satisfy the condition, one of them is selected according to a certain condition such as stock condition or by an electronic stock system, and this is loaded in the maintenance service assisting program. Moreover, information such as an cipher key required for accessing information required for maintenance is also loaded in the maintenance service assisting program and the program created is transmitted via the communication block 314 to the communication block 332 of the equipment maintenance client 330.

The system of the customer 11 uses the maintenance service assisting program received in assisting decision of maintenance order by the customer 11 (S203). In FIG. 9C, 930 represents this maintenance order decision screen. The decision reason setting field 931 shows the condition according to which the maintenance work assisting server 310 has decided that the condition is satisfied in step S107. For example, “deterioration is P % as compared to an equipment of identical type”. The service enterprise display field 932 displays the enterprise ID of the equipment maintenance service enterprise 13 selected as the most appropriate enterprise in step S108.

When the customer 11 wants to know the basis of the condition displayed, he/she specifies the basis display button 933. When this button is specified, the display/input block 331 causes the display device 1030 to display the basis display screen 1100 shown in FIG. 10. By using the selection tub 120, the customer can obtain conditions other than those set in the customer profile. For example, when the tub of part display 1124 is selected, by using the information on the part characteristic recorded in the equipment design information file 830, it is possible to obtain information to predict a timing of failure of the self-equipment according to the failure history of the parts belonging to the other equipment.

After observing such basis display screen 1100, if the customer wants to modify the customer profile data file 810, the customer specifies the profile modification button 934 to display the customer profile loading screen 910 and can correct the set contents. Moreover, after observing such basis display screen, if the customer agrees to make a maintenance order, he/she specifies the OK button 935. The equipment maintenance client 330 receives indication of the OK button 935 by the display/input block 331 (S204). The communication block 332 transmits a maintenance request to order maintenance to the equipment maintenance service enterprise 13 by using e-mail or other predetermined communication means. It should be noted that when the cancel button 936 is specified no order is made

Together with transmission of the maintenance request to the equipment maintenance enterprise, its copy is transmitted as a maintenance request report to the maintenance work assisting server 310 of the equipment maintenance information provider 12. Upon reception of this, the maintenance work assisting server 310 creates a maintenance enterprise assisting program necessary for maintenance ordered (S109). According to the maintenance enterprise profile data file 840 registered (loaded) in the profile recording block 312, information such as a cipher key for accessing necessary data information is set in the maintenance enterprise assisting program, which is transmitted via the communication block 314 to the communication block 342 of the maintenance service assisting device 340.

The equipment maintenance enterprise 13 can look at the contents of the maintenance enterprise assisting program in the display/input block 341 (S302). Information displayed includes the basis display screen such that observed by the customer and additionally stop/start procedure for stopping/starting the customer equipment 320, a maintenance history of the object equipment, and the like. It should be noted that the order reception confirmation can be transmitted to the customer.

These information items may be created in advance at the stage when the maintenance enterprise assisting program (S109) is created, or it is also possible that by dynamically communicating with the maintenance work assisting server 310 and the customer equipment 320 during operation of the maintenance service assisting device and collecting equipment information to create the display. In either case, the information is limited to the self-equipment disclosure level of the customer profile data file 810 recorded in the profile recording block 312. That is, information not to be disclosed to the other customers is not involved at the stage when the maintenance enterprise assisting program (S109) is created and cannot be accessed when equipment information is collected by communicating the customer equipment 320.

The equipment maintenance service enterprise 13 performs maintenance work of the equipment 320 by referencing the display of the maintenance enterprise assisting program (S303).

As a result, the maintenance service assisting program and the maintenance enterprise assisting program are used for a predetermined period of time and according to the time and the customer profile data which has been set in advance or the contents of the maintenance enterprise profile data, the user of the program is charged. For this, each of the maintenance service assisting program and the maintenance enterprise assisting program has a function to count the time the program is used and the function to count the data quantity displayed. By these function, the program utilization time and data utilization quantity are checked and the fee is calculated according to unit prices. The fee is presented to the customer and transmitted to the maintenance work assisting server 310. It should be noted that when transmitting the maintenance service assisting program and the maintenance enterprise assisting program, an initial fee may be determined so that a charging process may be performed in advance. In this case, the charging process is executed by the maintenance work assisting server 310.

On the other hand, by disclosing more information about the self-equipment, it is possible to improve the level of the maintenance service received. Moreover, by disclosing the self-equipment to the other customers, the other customers can receive benefits. For this, the program use charge may be reduced. For example, according to the data quantity provided, a discount percentage or discount price may be decided to reduce the aforementioned fee.

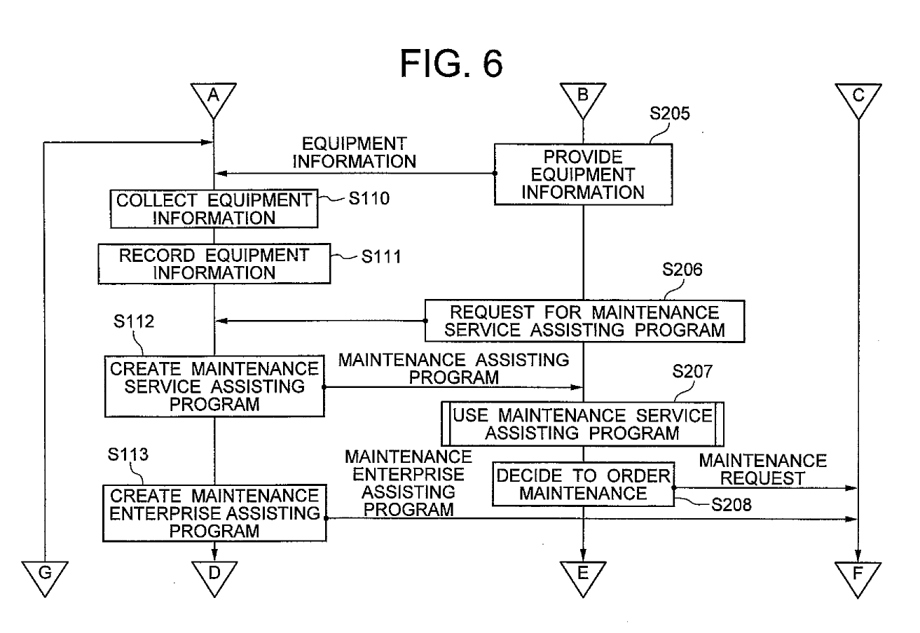

Next, referring to FIG. 3, FIG. 4, FIG. 6, and FIG. 7, explanation will be given on a system according to another embodiment of the present invention. In this system, the maintenance service assisting program is transmitted on request from a customer. Explanation will be given on this case. FIG. 3 shows a configuration of the system of the invention and FIG. 4, FIG. 6, and FIG. 7 show a specific example of the business procedure according to the second embodiment. Symbols A, B, C and the like in the flowchart show continuance of the flows. Like symbols are connected to each other.

Firstly, the equipment design information file 830 is recorded in advance in the equipment data recording block 313 of the maintenance work assisting server 310. As has been described above, the information on the equipment ID, components, parts characteristics are managed for each of the product ID.

Firstly, the maintenance work assisting server 310 belonging to the equipment maintenance information provider 12 transmits a customer profile format to the equipment maintenance client 330 of the customer 11 (S101). The equipment maintenance client 330, by using the format, displays a customer profile loading screen as shown in 910 of FIG. 9A in the display/input block 331 (S201). In the customer ID loading field 911, the customer ID input is accepted.

Next, the ID of the customer equipment to be subjected to a maintenance work is accepted in the object equipment setting field 912. Next, in the request service setting field 913, an operator enters a maintenance service content to be received for the equipment entered. Moreover, in the self-equipment disclosure level setting field 914, the operator enters a disclosure level of the equipment that can be disclosed to the others accompanying the service reception. Furthermore, the operator sets a condition to receive the maintenance service assisting program in the information provide frequency 915.

Lastly, the operator presses the service confirmation button 916 for confirmation and the information which has been set is transmitted via the communication block 332 to the communication block 314 of the maintenance work assisting server 310 and recorded in the profile recording block 312 (S102). When the cancel button 917 is pressed, the data which has been entered is cancelled and not transmitted.

Next, the maintenance work assisting server 310 belonging to the equipment maintenance information provider 12 transmits a format of the maintenance enterprise profile to the maintenance service assisting device 340 belonging to the equipment maintenance service enterprise 13 (S103). By using the format received, the maintenance service assisting device 340 displays a maintenance enterprise profile loading screen as shown by 920 in FIG. 9 (S301). In this state, an enterprise ID is accepted in the enterprise ID loading field 921. Next, in the object product setting field 922, a type of the equipment to be subjected to a maintenance work is accepted. Next, in the service content setting field 923, a maintenance service content which can be provided is accepted. Lastly, the confirmation button 924 is pressed for confirmation and the information which has been set is transmitted via the communication block 324 to the communication block 314 of the maintenance work assisting server 10 and recorded in the profile recording block 312. In case the cancel button 925 is pressed, the data entered is cancelled and not transmitted.

Like in the first embodiment, the steps S101, S102, S103, and S104 may occur in various orders and each of them may occur a plurality of times.

The customer equipment 320 collects and records necessary information by a predetermined method/cycle or a method/cycle specified by the maintenance work assisting server 310 (S205). The maintenance work assisting server 310 periodically accesses the record/delivery block 322 via the communication block 314 and fetches equipment information (S110). Alternatively, when a predetermined condition is satisfied, the record/delivery block 322 spontaneously transmits equipment information to the communication block 314 and the communication block 314 receives the information. The equipment information transmitted here may be limited by a content of the self-equipment disclosure level set in the customer profile data file 810. In either case, the equipment information received by the communication block 314 is recorded in the equipment data recording block 313 (S111).

When the customer 11 wants to know the condition of the self-equipment, the equipment maintenance client 330 receives indication from the customer 11 and requests the maintenance work assisting server 310 to transmit the maintenance service assisting program (S206). The maintenance work assisting server 310 automatically creates a maintenance service assisting program according to the request and transmits it via the communication block 314 to the communication block 332 of the equipment maintenance client 330 (S112).

The equipment maintenance client 330 assists the customer 11 to decide whether to order maintenance by using the maintenance service assisting program received (S207). Here, as has been described above, a screen as shown in FIG. 9C is displayed. The processing performed here is identical to the processing already explained and its explanation will not be repeated here. By looking such a basis display screen, if correction is required, a correction is performed then the OK button is pressed if an operator agrees to order maintenance (S208). Then, e-mail or other communication means is used to order maintenance to the equipment maintenance service enterprise 13. When the cancel button 936 is pressed, no order is performed. When the maintenance is ordered, a necessary maintenance enterprise assisting program is created in the maintenance work assisting server (S113) as has been explained above.

A process after this is performed according to the flow shown in FIG. 7. This is identical to the aforementioned embodiment and its explanation is omitted here.

Thus, the maintenance service assisting program and the maintenance enterprise assisting program are used for a certain time, and according to the time used, and a content of predetermined customer profile data or the maintenance enterprise profile data, a program use fee is charged. For the customer, by disclosing more of the information of the self-equipment, it is possible to improve the level of the maintenance service that can be received. Moreover, by disclosing more information about the self-equipment to the other customers, the other customers can have benefits. For this, the program use fee may be discounted.

According to the present invention, a customer can have information for objectively deciding whether to receive a maintenance service by the maintenance service assisting program provided by an analysis supporting program server and can receive a reasonable maintenance service at a lower cost. Moreover, on the other hand, the equipment maintenance information provider can provide maintenance assisting information without disclosing information and design information of the other customers more than necessary and can receive a fee. Moreover, even if a maintenance enterprise cannot perform infra investment for the remote control maintenance, by loading its service profile in the analysis server provided by the equipment maintenance information provider, it can receive maintenance order and information on the equipment associated with the maintenance service. Furthermore, according to a content of the customer profile, the content of the maintenance service assisting program can be modified, so as to modify the maintenance service content that can be received by the customer.

Moreover, by providing information in a program form, the customer and the equipment maintenance information provider can limit the information to be disclosed and prevent leak of secret information to the equipment maintenance service enterprise and other customers.

Moreover, as an entire market, it is possible to increase the number of customers, maintenance assisting information providers, and the maintenance enterprises, thereby increasing the maintenance information service market.

According to the present invention, a customer can have information required for objectively checking various maintenance services provided by a plenty of maintenance enterprises. Moreover, the present invention can assist the customer to receive a reasonable maintenance service at a low cost.

It should be further understood by those skilled in the art that the foregoing description has been made on embodiments of the invention and that various changes and modifications may be made in the invention without departing from the spirit of the invention and the scope of the appended claims.

1-16. (canceled)

17. An equipment maintenance work assisting method comprising:
accepting and storing in a maintenance work assisting server a maintenance service content which a customer has specified from a customer system and information indicating a range that can be disclosed about a customer equipment via a network;
fetching via the network and analyzing by the maintenance work assisting server equipment information about the customer equipment according to the maintenance service content which has been loaded from the customer system, to decide whether a condition for performing maintenance is satisfied; and
when it is decided that maintenance is required,
creating a maintenance service assisting program by the maintenance work assisting server for maintenance order including information that is a basis of determining the maintenance is required; and information required for maintenance order, and transmitting the program to the customer via the network.

18. An equipment maintenance work assisting method comprising:
accepting and storing in a maintenance work assisting server an available maintenance work menu from respective equipment maintenance service enterprise systems; and
when a maintenance order from a customer system to an equipment maintenance service enterprise is accepted in the maintenance work assisting server,
creating a maintenance enterprise assisting program by the maintenance work assisting server that includes information required for fetching equipment information of a customer who has submitted the maintenance order; and transmitting the program to the equipment maintenance service enterprise via a network.

19. An equipment maintenance work assisting method comprising:
accepting and storing in a maintenance work assisting server a maintenance service content which a customer has specified from a customer system and information indicating a range that can be disclosed about a customer equipment, via a network;
accepting and storing in the maintenance work assisting server an available maintenance work menu from respective equipment maintenance service enterprises;
fetching via the network and analyzing equipment information by the maintenance work assisting server about the customer equipment according to a maintenance service content which has been loaded from the customer system, and deciding whether a condition for performing maintenance is satisfied;
when it is decided that maintenance is required,
creating a maintenance service assisting program by the maintenance work assisting server that includes information necessary for maintenance order, including identification of an equipment maintenance service enterprise, and transmitting the program to the customer system via a network; and
upon acceptance of a maintenance order from a customer system to an equipment maintenance service enterprise, creating a maintenance enterprise assisting program by the maintenance work assisting server that includes information necessary for fetching the equipment information of the customer who has submitted the maintenance order, and transmitting the maintenance enterprise assisting program to the equipment maintenance service enterprise system via the network.

20. The equipment maintenance work assisting method according to claim 17, further comprising the steps of:
accepting, in addition to the maintenance service content, further equipment information of the customer equipment that can be disclosed, and creating and storing statistical data about the equipment maintenance; and
transmitting the statistical data to a customer system which has made a request for the data.

21. The equipment maintenance work assisting method according to claim 18, further comprising the steps of:
accepting, in addition to the maintenance service content, equipment information of the of the customer equipment which can be disclosed and creating statistical data concerning the equipment maintenance; and
upon reception of a request from an equipment maintenance service enterprise, transmitting the statistical data to the equipment maintenance service enterprise system.

22. A maintenance work assisting server comprising:
a communication block for communication with customer systems via a network;
a profile storage block for accepting and storing a maintenance service content, which includes equipment identification and maintenance policy, requested by a customer via a customer system;
an equipment data storage block for storing equipment information concerning a customer equipment of the customers registered (loaded) in the profile recording block according to the maintenance service content; and
an analysis block for analyzing the equipment information recorded in the equipment data recording block, deciding whether maintenance of the equipment is required; and when maintenance is required, creating a maintenance service assisting program for use in maintenance order and transmitting the program to a corresponding customer system via the communication block.

23. A maintenance work assisting server comprising:
a communication block for communicating via a network with respective equipment maintenance service enterprises;
a profile recording block for accepting available maintenance work menu loaded by the respective equipment maintenance service enterprises and storing the menu; and
an analysis block for accepting a maintenance order from a customer system to a maintenance service enterprise and creating a maintenance enterprise assisting program that includes information for fetching equipment information of a customer which has ordered the maintenance, and that is used for performing the maintenance, and transmitting the program via the communication block to the corresponding maintenance service enterprise system.

24. A maintenance work assisting server comprising:
a communication block for communicating with customer systems and equipment maintenance service systems via a network;
a profile recording block for accepting and storing an maintenance service content, which includes equipment identification and maintenance policy, requested from a customer system, and accepting an available maintenance work menu loaded by an equipment maintenance service enterprise and storing the menu: and
an analysis block for fetching equipment information concerning a customer equipment according to the maintenance service content from the customer system and analyzing the information,
wherein when a maintenance condition is satisfied and a corresponding maintenance is decided to be performed, a maintenance service assisting program is created that includes information serving as a basis for requiring the maintenance and information required for maintenance order including identification of a maintenance service enterprise and the program is transmitted via the communication block to the corresponding customer system, and
upon acceptance of a maintenance order from a customer to a maintenance service enterprise via the communication block, a maintenance enterprise assisting program is created that includes information necessary for fetching the customer equipment information ordered by the customer, and that is used for performing maintenance, and the program is transmitted via the communication block to the maintenance service enterprise system.

25. The maintenance work assisting server according to claim 22 wherein
the profile storage block further stores equipment information of the customer equipment transmitted from the customer system which can be disclosed; and
the analysis block generates statistic data concerning the equipment maintenance according to the equipment information of the customer equipment which has been recorded and can be disclosed; and
the equipment data recording block further stores the statistic data and upon request from a customer system, transmits the statistic data to the customer system via the communication block.

26. The maintenance work assisting server according to claim 23, wherein
the profile recording block further stores the equipment information of the customer equipment that is transmitted from the customer system and can be disclosed;
the analysis block generates statistic data concerning the equipment maintenance according to the equipment information of the respective customer equipment that is recorded and that can be disclosed; and
the equipment data recording block further stores the statistic data, and when a request is made from a maintenance service enterprise system, the equipment data recording block transmits the statistic data to the maintenance service enterprise via the communication block.

27. The maintenance work assisting server according to claim 22 wherein
the maintenance service assisting program generated by the analysis block is a program causing a computer to execute the following: a reason present function for presenting a reason according to which the decision for maintenance is based upon; a service enterprise present function for displaying a service enterprise appropriate for providing the maintenance service; a basis present function for presenting the basis upon request; a profile modification input acceptance function for accepting modification input when a request for modifying the customer profile is received; and an order specifying function for accepting an order specification.

28. The maintenance work assisting server according to claim 22, wherein
the maintenance service assisting program displays characteristic values, inspection cycle and inspection content of the customer equipment in comparison to an average value of the identical apparatus and standard deviation data.

29. The maintenance work assisting server according to claim 23, wherein
the maintenance enterprise assisting program created by the analysis block is a program causing a computer to execute the following: a reason present function for presenting a reason according to which the decision for maintenance is based upon; an object customer/equipment display function for displaying a customer and equipment to receive the maintenance service; a basis present function to display a basis when requested to display the basis; a stop/start procedure display function for fetching and displaying information indicating the stop procedure and start procedure of the object equipment; and an access allow processing function for processing about the accessing the customer data.

30. The maintenance work assisting server according to one of claims 24, wherein
the analysis block adds at least one of the following to the maintenance service assisting program and the maintenance enterprise assisting program: customer equipment replacement timing, advice to select a type of equipment for replacement, and a maintenance enterprise and maintenance menu of the maintenance enterprise.

31. The maintenance work assisting server according to claims 24, wherein
the analysis block includes a transmission decision block for deciding a transmission destination, a transmission timing, and a transmission frequency of the maintenance service assisting program of the maintenance enterprise assisting program by using at least one of the following: the customer profile, the maintenance enterprise profile, equipment design information, repair information, and parts lot information.

32. The maintenance work assisting server according to claims 24, wherein
the analysis block decides a fee of the maintenance service assisting program or the maintenance enterprise assisting program transmitted, according to the contents of the customer profile or the maintenance enterprise profile.

33. The method according to claim 17 further comprising connecting the maintenance work assisting server to the customer systems via the network so as to assist the customer systems.

34. The method according to claim 18 further comprising connecting the maintenance work assisting server to the equipment maintenance service enterprise systems.

35. The method according to claim 19 further comprising connecting the maintenance work assisting server to customer systems and equipment maintenance service enterprise systems via the network so as to assist the customer systems.

36. The maintenance work assisting server according to claim 22, wherein the respective customer systems are connected via the network and the server assists the customers in an equipment maintenance work via the network.

37. The maintenance work assisting server according to claim 23, wherein the server is connected to an equipment maintenance service enterprise system via the network for assisting the equipment maintenance service enterprise systems via the network.

38. The maintenance work assisting server according to claim 24, wherein the server is connected to the respective customer systems and respective equipment maintenance service enterprise systems via the network for assisting the customer system and equipment maintenance service enterprises in an equipment maintenance work.
